(19) United States
(12) Patent Application Publication
(10) Pub. No.: US 2026/0351835 A1
(43) Pub. Date: Nov. 5, 2026

(54) EMBEDDED ANTENNA BOOSTER SYSTEM

(71) Applicant: IGNION, S.L., Sant Cugat del Vallès (ES)

(72) Inventors: Jaume ANGUERA, Vinaròs (ES); Aurora ANDÚJAR, Sant Cugat del Vallès (ES); Alejandro FERNÁNDEZ, Sant Cugat del Vallès (ES)

(21) Appl. No.: 19/715,449

(22) Filed: Jun. 22, 2026

Related U.S. Application Data
(63) Continuation of application No. PCT/EP2024/088326, filed on Dec. 23, 2024.

(30) Foreign Application Priority Data
Dec. 22, 2023 (EP) 23383373.0

(51) Int. Cl. H01Q 1/22; H01Q 19/02

(52) U.S. Cl. CPC H01Q 1/22; H01Q 19/025

(57) ABSTRACT

A wireless device that is capable of operating in a frequency region or a frequency band includes a radiating system comprising: a radiating structure, and I/O port, and a radiofrequency system. The radiating structure comprises an embedded structure in a dielectric support that comprises an antenna element, such as booster element or radiation booster, a feeding line, such as a conductive strip, a pads layout for allocating a matching network, an electrical connection from a first layer to a second layer of the dielectric support, and a dielectric material. The radiating structure further comprises a ground plane layer. In some embodiments, the ground plane layer of the radiating structure is in the dielectric support of the embedded structure.

### CROSS REFERENCE TO RELATED APPLICATIONS

This application is a bypass continuation application of PCT International Application No. PCT/EP2024/088326, filed on Dec. 23, 2024, which claims priority to European Application No. 23383373.0, filed on Dec. 22, 2023, the entire contents of which are hereby incorporated by reference.

### TECHNICAL FIELD

The present disclosure relates to the field of wireless devices, able to operate in at least a frequency region and/or frequency band.

### BACKGROUND

Wireless devices able to operate in at least a frequency region and/or frequency band including non-resonant antenna elements, as it is the case for a wireless device using VAT technology, provide a non-customized solution in view of the antenna element, which can be allocated in small spaces in a PCB. There exists in literature VAT technology solutions, like for example the ones included and described in WO2010/015365, WO2014/012842, which comprise radiation boosters. These solutions are non-customized solutions in view of the radiation booster, but they are not in view of the matching network and the corresponding pads layout, since the matching network needs to be designed and tuned for each PCB or device. WO2023/067196 discloses reconfigurable solutions for wireless devices by providing non-customized and versatile matching networks integrated in radiating systems comprising a non-resonant element, a ground plane element and a wireless matching core comprising those matching networks. But in WO2023/067196, a way of fabricating those solutions is not disclosed. In WO2014/012842, manufacturing methods of radiation booster structures are disclosed, but the solutions proposed are not non-customized solutions. The different designs of the matching network layouts used for each PCB introduce a variable that sometimes makes difficult the integration and design of a VAT solution. If a standard matching network pads layout is used, a client or a VAT pads technology designer will not have to worry about how to implement the matching network pads and layout in the PCB, easing the integration of the technology. So, having a VAT solution where the radiation booster and matching network pads layout are non-customized designs is an advantageous solution and a further step in the VAT technology evolution.

### SUMMARY

The present disclosure relates to a wireless device, able to operate in at least one frequency region and/or frequency band, comprising a radiating system that comprises a radiating structure comprising an embedded structure in a dielectric support, the embedded structure comprising an antenna element, advantageously being in some examples a booster element or radiation booster, a feeding line, typically comprising a conductive strip, at least one electrical connection from a first layer to a second layer of the dielectric support, and a dielectric material; the radiating structure also comprising at least one ground plane layer. Typically, at least one of the electrical connections from a first layer to a second layer is connected to a transceiver, to ground, to other circuit components or elements, or to an input/output port of the radiating system. A radiating system comprising a radiating structure according to the present disclosure also comprises at least one input/output port, and a radiofrequency system that comprises a matching network or circuit that is allocated in a pads layout, the matching network being connected to one of the input/output ports of the radiating system. In some radiating system embodiments, the pads layout is also in the embedded structure of the radiating structure, so being in a same dielectric support as the one that includes the embedded structure. And in other embodiments, the pads layout is in a portion of a ground plane layer of the radiating structure, preferably being a ground plane layer of a dielectric support that also includes the embedded structure. But, there are other radiating system embodiments where the pads layout is in a portion of a ground plane layer that is not in a dielectric support of the embedded structure. So, in some radiating structure embodiments, at least one of the at least one ground plane layer of the radiating structure is in the dielectric support of the embedded structure. In some of these last embodiments, the dielectric support of the embedded structure and a ground plane layer of the radiating structure is contained in a PCB (printed circuit board). And in other radiating structure embodiments, at least one of the at least one ground plane layer of the radiating structure is not in the same dielectric support as the embedded structure.

It is interesting to note that a wireless device according to the disclosure is able to operate at any wireless communication protocol, covered by the corresponding frequency regions and/or frequency bands.

As mentioned before, an embedded structure related to the disclosure comprises an antenna element, advantageously being a radiation booster or a booster element in some examples. In the context of this disclosure, a radiation booster or booster element refers to a radiation booster as described and defined in the patent documents WO2010/015365 A2, WO2014/012842 A1 and WO2016/012507 A1, incorporated by reference herein. The antenna element is, in other embodiments, an electrically-short antenna. A radiation booster typically features a maximum size smaller than the free-space wavelength divided by 20 at the lowest frequency of a first frequency region of operation and, according to this disclosure, an electrically-short antenna features a maximum size between the free-space wavelength divided by 20 and the free-space wavelength divided by 5, also at the lowest frequency of a first frequency region of operation. Some examples of a radiating structure related to the present disclosure comprise a modular antenna element that provides flexibility on the radiating structure configuration in view of, for example, the frequency bands of operation. The modular antenna element comprises, in some examples, more than one section comprising at least a radiation booster. A matching network of a radiofrequency system of a radiating system according to this disclosure, comprises passive circuit components in some embodiments like, for example, capacitors or inductors, and active components in other embodiments, as for example switches or tunable components, diodes, transistors, etc., but the elements or components of a matching network of a radiofrequency system included in a radiating system related to this disclosure are not limited to the previously mentioned ones. The matching network elements or components can be combined in different matching network topologies, such as, only having a series component, a T-topology, a π-topology, these topologies being examples but not a limitation of the topologies that can be implemented for a radiating system embodiment related to this disclosure. The dielectric material comprised in the embedded structure that comprises the antenna element, the feeding line and the matching network pads layout is the air in some embodiments, FR4 material in other embodiments, or any other dielectric material in other embodiments. A dielectric support comprising an embedded structure related to the disclosure can feature any thickness. Also, in a radiating system embodiment where the dielectric support comprising the embedded structure and a ground plane layer of the radiating structure is contained in a PCB (printed circuit board), the PCB can feature any shape and dimensions. Also, a ground plane layer of a radiating structure related to this disclosure can also feature any shape, typically being, in some examples, a polygon of at least three sides and three angles defining any shape. Some radiating structure embodiments comprise a ground plane layer or layers featuring a shape defined by at least one round side, so being a circle in some cases. Regarding the dimensions of the at least one ground plane layer of a radiating structure according to the present disclosure, there exist radiating structure embodiments comprising at least one of the at least one ground plane layers being equal to or bigger than 0.1 times the wavelength (λ) at a lowest frequency of a first frequency band of operation, and there exist other embodiments where the at least one of the at least one ground plane layers are smaller than 0.1 times the wavelength λ at a lowest frequency of a first frequency band of operation. So, a characteristic of a radiating system according to this disclosure is that an embedded structure provides a proper performance, in terms of radiation or antenna efficiency and input matching, and it is easy to integrate, independently from the shape of the ground plane layer of the radiating structure and of the PCB. Additionally, the dimensions of a ground plane layer of a radiating structure related to this disclosure can be smaller than 0.1 times the wavelength λ at a lowest frequency of a first frequency band of operation.

An antenna element of an embedded structure related to this disclosure comprises at least one conductive surface in at least one conductive layer. So, some embodiments comprise a single conductive layer antenna element comprising the antenna element conductive surface or surfaces, the antenna element being, in some of these examples, a conductive strip; and, in other embodiments, the conductive surfaces of the antenna element are in more than one conductive layer. Some of these last embodiments comprise conductive layers or conductive surfaces featuring different shapes. Typically, an embedded radiating system embodiment comprising an embedded radiation booster according to the present disclosure comprises two conductive surfaces in two parallel conductive layers. The shape of the conductive surfaces or of the conductive layers of a radiation booster related to the disclosure can be different between them or they can feature the same shape and even the same dimensions. And an antenna element, being radiation booster or not, according to this disclosure can feature any shape.

An antenna element of an embedded structure related to this disclosure is connected to the feeding line also in the embedded structure, the feeding line also connected to the pads for allocating a matching network. The matching network is connected to an input/output port of the radiating system or to a transceiver. In some embodiments, the connection between the matching network and the I/O port or the transceiver is done through at least one of the electrical connections of the embedded structure going from a first layer to a second layer.

A characteristic of the disclosed device is that the dielectric material included in the embedded structure fulfills all the embedded structure volume surrounding all the elements in the embedded structure, as well as filling the space between the conductive surfaces of a radiation booster, for the case of embodiments comprising radiation boosters. Some embodiments related to the present disclosure contain a feeding line connecting the antenna element to the matching network pads wherein the feeding line is a conductive strip at a height above a plane containing the ground plane layer comprised in the radiating structure. Having a conductive strip for the feeding line, the conductive strip being on a surface of the embedded structure at a height from the ground plane layer included in the radiating structure, allows obtaining better radiation efficiencies, so contributing to a better radiation performance. In other embodiments of a radiating structure related to this disclosure where the ground plane layer is not in the dielectric support that comprises the embedded structure, like in the embodiments mentioned just before, the performance in terms of input reflection coefficient and antenna efficiency also improves with respect to a prior-art radiating structure. In some of those embodiments, the feeding line comprising a strip connecting the antenna element and the matching network pads is printed on a PCB where the embedded structure is mounted. As already disclosed before, other embodiments according to the present disclosure comprise an embedded structure comprising an antenna element or a radiation booster integrated in a PCB, the PCB containing a dielectric support comprising the embedded structure and a ground plane layer of the radiating structure. Those embodiments are advantageously cheaper than fabricating and integrating a prior-art chip radiation booster, while preserving a good performance at least in terms of radiation efficiency. Regarding a printed radiation booster integrated in a radiating structure, an embedded radiating structure integrated in a PCB like the one disclosed here provides better radiation efficiency performance and it is as cheap as a printed radiation booster.

Some other radiating structure embodiments according to the present disclosure contain an embedded structure comprising a matching network pads layout containing pads for allocating an active component, the active component being a switch in some examples. Other radiating structures related to this disclosure comprise an embedded structure integrated on a PCB containing a ground plane layer so that at least a portion of the projection of the embedded structure onto a plane containing the ground plane layer of the radiating structure overlaps a ground plane rectangle, defined in the context of this disclosure as a smallest parallelepiped that encompasses the ground plane layer of the radiating structure. Typically, in some of these embodiments, the embedded structure is integrated at a corner of the ground plane rectangle. Additionally, some of all those embodiments comprise at least one electrical connection from a first layer to a second layer comprising at least one half-via, the at least one half-via typically connecting the matching network pads layout, and consequently the matching network allocated in it, to ground or to an I/O port, or to a transceiver, or to other circuit components.

A radiating system related to the present disclosure can be connected to an additional ground plane. The additional ground plane can be a ground plane in a second PCB or in a device, as for example, but not limited to, a laptop computer, a tablet, or a dock station. And the connection between the radiating system and the additional ground plane can be done at any position of the ground plane, being particularly done at the center of an edge, by any means.

The present disclosure also relates to a method, for example a method for manufacturing a wireless device or arranging a radiating system within a wireless device as previously described. The method comprises arranging a radiating structure within a wireless device. The radiating structure comprises an embedded structure in a dielectric support and at least one ground plane layer. The embedded structure is preferably an embedded structure according to the present disclosure. In this sense, the embedded structure, for example, at least comprises: an antenna element comprising at least one conductive surface in at least one conductive layer, a feeding line, at least one electrical connection from a first layer to a second layer, and a dielectric material. The method also comprises arranging at least one I/O port within the wireless device. The method also comprises arranging, within the wireless device, a radiofrequency system that comprises a matching network or circuit on a pads layout. In some embodiments, the radiating structure is arranged within the wireless device such that at least one layer of the at least one ground plane layer is not in the dielectric support. In some other embodiments, at least one layer of the at least one ground plane layer of the radiating structure is in the dielectric support.

### BRIEF DESCRIPTION OF THE DRAWINGS

The mentioned and further features and advantages of the disclosed devices and methods become apparent in view of the detailed description which follows with some examples of the devices and methods, referenced by the accompanying drawings, given for purposes of illustration only and in no way meant as a definition of the limits of the invention.

FIG. 1 illustrates a radiating structure embodiment comprising an embedded structure in a dielectric support including a radiation booster, a feeding line comprising a conductive strip, some pads for allocating a matching network, a dielectric material and at least one electrical connection going through the dielectric material from a first layer to a second layer.

FIG. 2 shows an input reflection coefficient and antenna efficiency obtained for the two radiating structures provided in the graph: a prior-art radiating structure (dashed lines) and a radiating structure including an embedded structure related to the present disclosure (solid lines), when matched with the matching network provided in FIG. 3.

FIG. 3 illustrates a matching network used to match the radiating structures provided in FIG. 2.

FIG. 4 shows a radiation efficiency comparison for a radiating structure including an embedded structure related to the present disclosure where (a) the strip connecting the radiation booster and the matching network pads is printed on the PCB where the embedded structure is mounted, and (b) the strip connecting the radiation booster and the matching network pads is printed at a height from the ground plane layer of the radiating structure on a surface of the embedded structure.

FIG. 5 illustrates a radiating structure embodiment related to the present disclosure where at least a part of the projection of the embedded structure onto a plane containing the ground plane layer of the radiating structure overlaps the ground plane layer.

FIG. 6 illustrates radiating structure embodiments according to a prior-art case (top) and to the present disclosure (middle and below). The embodiment in the middle contains an embedded radiation booster integrated in the PCB allocating the radiating structure. The embodiment below contains a printed radiation booster, with no volume.

FIG. 7 shows a radiation efficiency obtained (by simulation) for the three radiating structures provided in FIG. 6.

FIG. 8 illustrates an example of an embodiment of a radiating system according to the present disclosure containing an embedded structure that comprises an embedded radiation booster integrated in the PCB for the radiating structure. In this example, different sizes of ground plane and PCB are considered.

FIG. 9 illustrates an example of a radiating system embodiment according to the disclosure, comprising an embedded structure that comprises an embedded radiation booster integrated in the PCB for the radiating structure, the radiating system being connected to an additional ground plane at the center of an edge. The additional ground plane can be a ground plane of an additional PCB or in a device, as for example, but not limited to, a laptop computer, a tablet, or a dock station.

FIG. 10 shows an input reflection coefficient and antenna efficiency measured for the radiating system embodiment provided in FIG. 9, and compared to the input reflection coefficient and antenna efficiency measured for the radiating system embodiment without being connected to the additional ground plane.

FIG. 11 illustrates another example of a radiating system embodiment comprising an embedded structure that comprises an embedded radiation booster integrated in the PCB for the radiating structure. In this particular example, the top conductive surface of the radiation booster contains a hole in the center, the top conductive surface featuring a closed ring shape.

FIG. 12 illustrates another example of a radiating system embodiment related to the present disclosure, comprising an embedded structure that comprises an embedded radiation booster integrated in the PCB for the radiating structure, where the PCB and the ground plane of the radiating structure feature a polygonal shape different from a rectangle, with a perforated surface.

### DETAILED DESCRIPTION

The mentioned and further features and advantages of the disclosed devices and methods become apparent in view of the detailed description, which follows with some examples thereof, referenced by the accompanying drawings, given for purposes of illustration only and in no way meant as a definition of the limits of the invention.

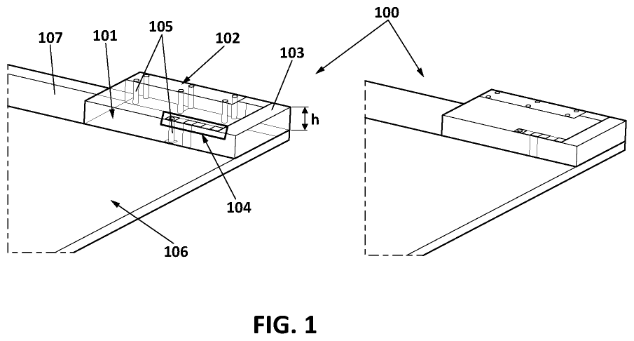

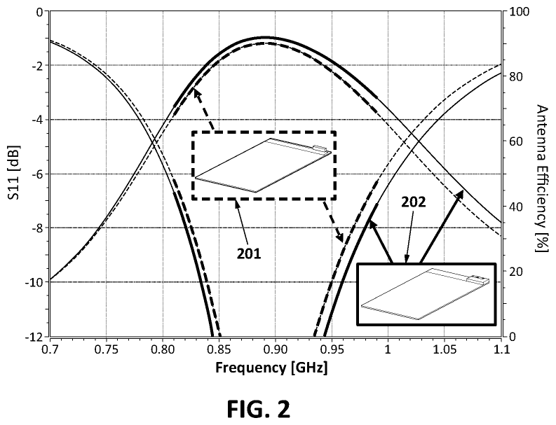

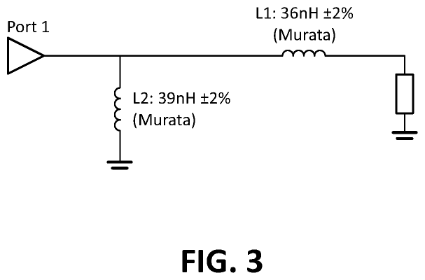

FIG. 1 provides a radiating structure embodiment 100 related to this disclosure, the radiating structure comprising an embedded structure in a dielectric support 101 that comprises a radiation booster 102, a feeding line 103 comprising a conductive strip, some pads disposed in a pads layout 104 for allocating a matching network, a dielectric material and at least one electrical connection 105 going through the dielectric material from a first layer to a second layer; the radiating structure also comprising a ground plane layer 106. For this embodiment, the embedded structure is located at a corner of a ground plane rectangle on a clearance 107 of a ground plane layer of a printed circuit board (PCB), the ground plane rectangle encompassing the ground plane layer. The radiation booster 102 of the embedded structure comprises two conductive surfaces in two parallel layers, the conductive surfaces being connected between them by more than one electrical connection, those electrical connections usually being vias. The conductive strip of the feeding line 103 connects the radiation booster 102 to the matching network pads and to the matching network that can be allocated in those pads. The dielectric material included in the embedded structure fills all the embedded structure volume surrounding all the elements of the embedded structure as well as filling the space between the conductive surfaces of the radiation booster 102. Surprisingly, the fact of having a dielectric material surrounding the radiation booster 102 does not worsen the performance achieved, but on the contrary, as seen in FIG. 2, the input reflection coefficient and the antenna efficiency may improve, or at least it is not worse, with respect to the ones obtained for a prior-art radiating structure. The matching network provided in FIG. 3 is that of a radiating system comprising the radiating structures presented in FIG. 2.

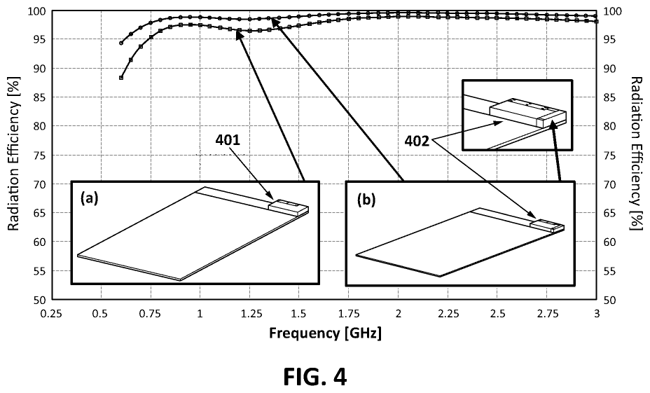

A particular characteristic of the embedded structure provided in FIG. 1 is that the conductive strip of the feeding line 103 is located at a height “h” above the plane containing the ground plane layer 106 of the radiating structure 100. FIG. 4 provides a comparison of the radiation efficiency obtained for two radiating structures including an embedded structure related to the present disclosure, comprising a strip that connects a radiation booster to a matching network pads layout. In one of those radiating structures, the strip is printed on the PCB where the embedded structure is integrated or mounted, the strip being printed below the embedded structure; and in the other radiating structure the strip connecting the radiation booster and the matching network pads is printed on a surface of the embedded structure, at a height from the ground plane layer included in the radiating structure. As evidenced in FIG. 4, printing the strip on a surface of the embedded structure, at a height from the ground plane layer, allows obtaining better radiation efficiencies, contributing to a better performance.

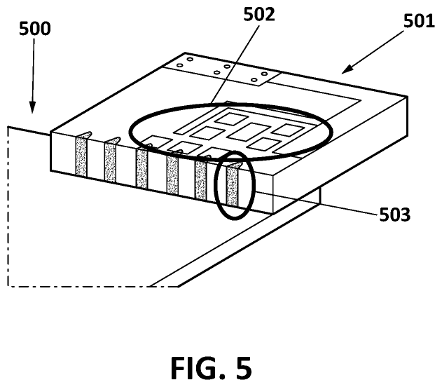

FIG. 5 provides a radiating structure embodiment 500 according to the present disclosure where at least a part of the projection of the embedded structure 501 onto a plane containing the ground plane layer of the radiating structure overlaps a ground plane rectangle, defined as a smallest parallelepiped that encompasses the ground plane layer of the radiating structure. In this embodiment, the embedded structure is integrated at a corner of the ground plane rectangle. Additionally, the matching network pads layout 502 included in the embodiment from FIG. 5 allows the integration of a switch, and the embedded structure contains at least one electrical connection from a first layer to a second layer comprising at least one half-via 503, the at least one half-via typically connecting the matching network pads layout, and consequently the matching network, to ground or to an I/O port, or to a transceiver, or to other circuit components.

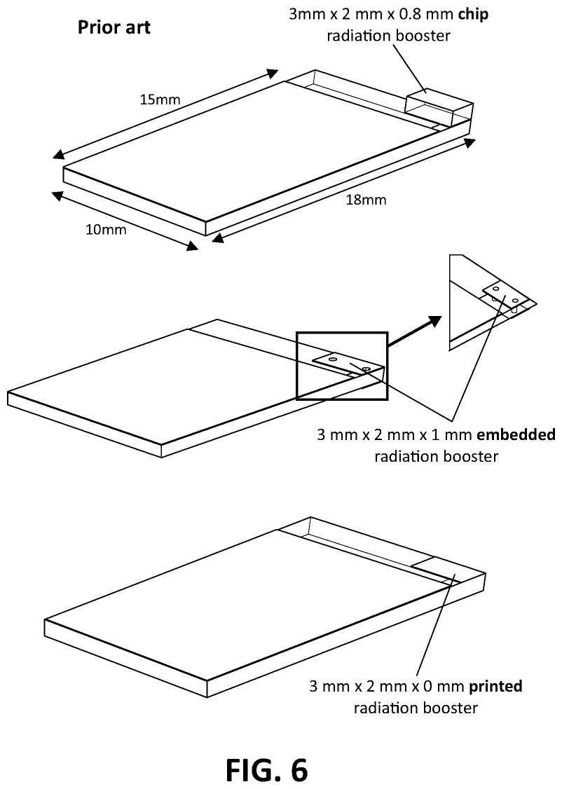

FIG. 6 provides some radiating structures according to the present disclosure. One of them advantageously comprises an embedded structure comprising a radiation booster integrated in a PCB, the PCB containing a dielectric support comprising the embedded structure and a ground plane layer in the radiating structure. In this particular example, the embedded radiation booster features 3 mm×2 mm×1 mm dimensions and comprises two conductive surfaces connected between them through vias, the conductive surfaces being printed on a clearance of 10 mm×3 mm of the PCB. The dielectric material of the PCB is then the one between the conductive surfaces of the embedded radiation booster. The embedded radiation booster, in this particular example, is located at 1 mm from an edge of the ground plane layer of the radiating structure. The ground plane layer features a length of 0.1 times the wavelength (λ) at a lowest frequency of operation, in this example being 2.4 GHz, and a width of 10 mm. Also in FIG. 6, a radiating structure containing a printed radiation booster is provided, the printed radiation booster comprising a conductive surface that features a two-dimensional shape, so with no volume, and that is printed on a clearance of a PCB containing a dielectric support, the clearance being in this particular example 10 mm×3 mm. The printed radiation booster in the example features a 3 mm×2 mm size and the ground plane layer of this radiating structure features a length of 0.1 times the wavelength at a lowest frequency of operation, being 2.4 GHz in the example. The printed radiation booster located at 1 mm from an edge of the ground plane layer. The embodiments provided in FIG. 6 are configured to operate in a frequency range going from 2.4 GHz to 2.5 GHz.

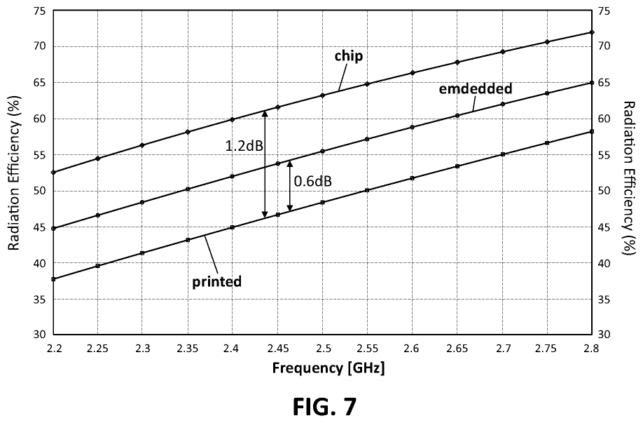

Fabricating and integrating an embedded radiation booster in a radiating structure according to the present disclosure is advantageously cheaper than fabricating and integrating a prior-art chip radiation booster, while preserving a good performance at least in terms of radiation efficiency. Though, a radiating structure comprising a chip radiation booster can provide better performance in terms of radiation efficiency than a radiating structure comprising an embedded radiation booster, as shown in FIG. 7 for the examples provided in FIG. 6. Fabricating a printed radiation booster is also more advantageous regarding cost than fabricating and integrating a chip radiation booster, but it is similar in cost as fabricating an embedded radiation booster. Regarding performance in terms of radiation efficiency, for the particular examples of Error: Reference source not found, a 0.6 dB difference in radiation efficiency is observed between a printed radiation booster with respect to an embedded radiation booster, and between an embedded radiation booster with respect to a prior-art radiation booster.

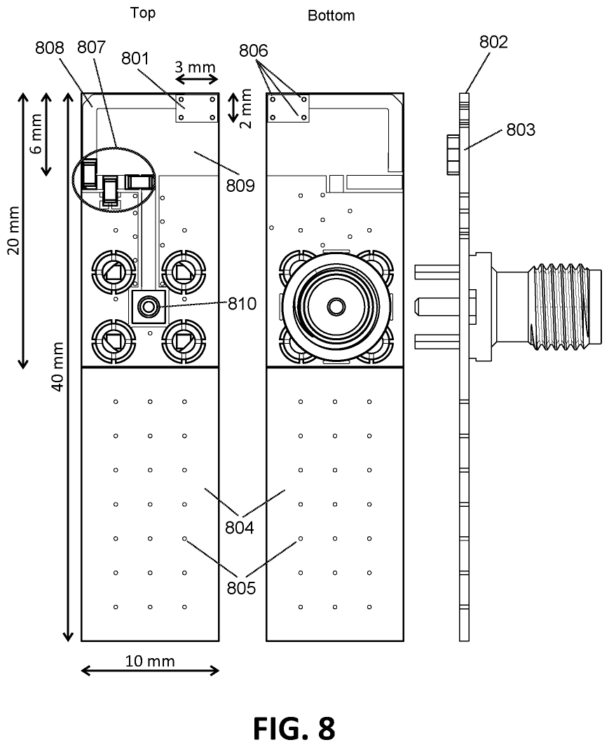

FIG. 8 presents a radiating system embodiment according to this disclosure, comprising an embedded structure that comprises an embedded radiation booster 801, the embedded structure and radiation booster integrated in the PCB 802 that are part of the radiating structure. The PCB contains a dielectric support 803 that comprises the embedded structure and the ground plane 804 of the radiating structure, the ground plane comprising in this example two layers interconnected by vias 805. In this example, different sizes of ground plane and PCB are considered, so different embodiments with different PCB and ground plane sizes can be implemented, more concretely, two embodiments with PCBs of 20 mm and 40 mm of length by 10 mm of width have been fabricated. The radiation booster features 3 mm×2 mm×0.6 mm dimensions and comprises two conductive surfaces featuring a same rectangular shape, spaced between them by the dielectric support of 0.6 mm thickness contained in the PCB, and connected between them by vias 806, particularly 4 vias placed near the four corners of the radiation booster. The radiation booster is connected to a matching network 807 by a conductive strip 808, on a top layer or face of the PCB, the radiation booster and the conductive strip having a ground plane clearance 809 of 10 mm×6 mm on the top ground plane layer. A particular matching network used for providing impedance match to this embodiment in Wi-Fi frequencies, concretely in the 2.4 GHz to 2.483 GHz band, contains only a series inductance of 6.3 nH value. The matching network is formed on a pads layout that is on a portion of the ground plane layer at the top layer or face of the PCB. The matching network of the radiofrequency system of the radiating system is connected to an input/output port 810.

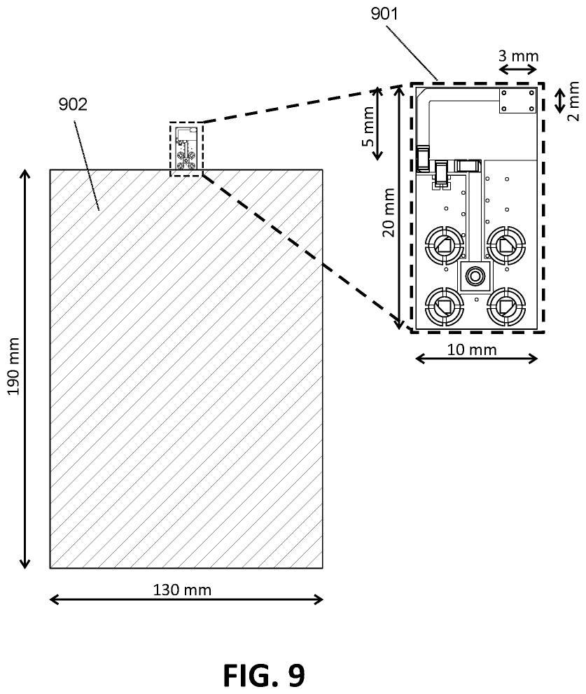

FIG. 9 presents an embodiment of a radiating system 901 related to the present disclosure connected to an additional ground plane 902, particularly at the center of an edge, and the additional ground plane featuring 190 mm×130 mm dimensions. The radiating system embodiment comprises an embedded structure that comprises an embedded radiation booster, the whole embedded structure integrated in the PCB of the radiating structure. Particularly, the radiating system embodiment connected to an additional ground plane in FIG. 9 is the one shown and described in FIG. 8 with a PCB of 20 mm long. The additional ground plane can be a ground plane in a second PCB or in a device, as for example, but not limited to, a laptop computer, a tablet, or a dock station. And the connection between the radiating system and the additional ground plane can be done at any position of the ground plane by any mechanism, for this and for other embodiments.

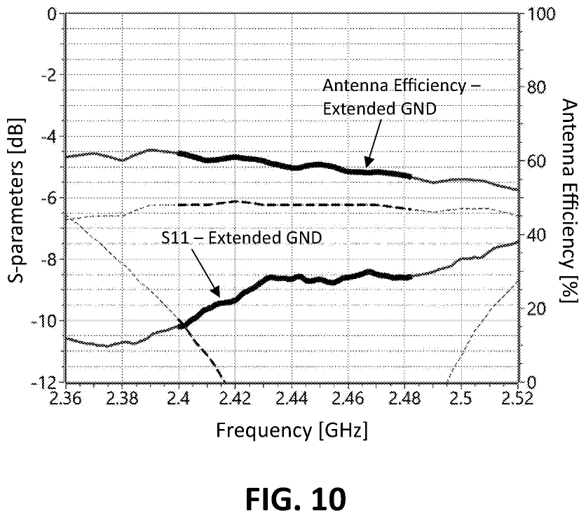

FIG. 10 provides measurements done for the radiating system shown in FIG. 9, and described in more detail in FIG. 8, without being connected (dotted lines) and being connected (solid lines) to an additional ground plane as presented in FIG. 9. The input reflection coefficient and the antenna efficiency obtained are provided and they show that the performance of the radiating system is not getting worse because of connecting it to the additional ground plane, but on the contrary, the antenna efficiency improves at least a 10% in the whole operation band, being in this example from 2.4 GHz to 2.483 GHz, frequency band comprised in Wi-Fi frequencies. The input reflection coefficient changes but it remains very appropriate, still showing good impedance match in the band of interest.

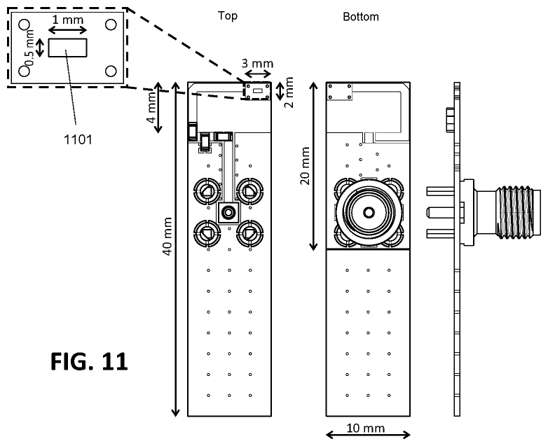

FIG. 11 provides another radiating system embodiment related to the disclosure, comprising an embedded structure that comprises an embedded radiation booster, the embedded structure and radiation booster being integrated in the PCB of the radiating structure. This embodiment is quite similar to the one described in FIG. 8, but in the particular example from FIG. 11, the top conductive surface of the embedded radiation booster contains a hole 1101 in the center of the surface, the top conductive surface featuring a closed ring shape then. The hole features 1 mm (length)×0.5 mm (width) dimensions. The bottom conductive surface of the radiation booster is a rectangle surface without any hole. So, this embodiment is an example of a radiating system according to the present disclosure, wherein the different conductive layers or surfaces of the embedded radiation booster do not feature the same shape. Also, in this embodiment, the embedded radiation booster and the conductive strip that connects the radiation booster to the matching network of the radiofrequency system of the radiating system have a ground plane clearance of 10 mm×4 mm. The rest of the features described for the embodiment from FIG. 8 are the same for the embodiment from FIG. 11. An embodiment integrated in a PCB of 40 mm×10 mm size has been matched with a matching network comprising only a series inductance of value 6.3 nH, and an embodiment integrated in a 20 mm long PCB has also been matched with a series inductance, but of value 7 nH. Those matching networks are implemented for matching the embodiments in Wi-Fi frequency bands, more concretely from 2.4 GHz to 2.483 GHz.

It is worth noticing that radiating system embodiments comprising an embedded structure that comprises an embedded radiation booster, the whole embedded structure integrated in the PCB of the radiating structure, like the ones from FIG. 8 and FIG. 11, perform very well in terms of antenna efficiency, providing around 45% of antenna efficiency average for 20 mm×10 mm PCBs and up to 80% of antenna efficiency average for 40 mm×10 mm PCBs.

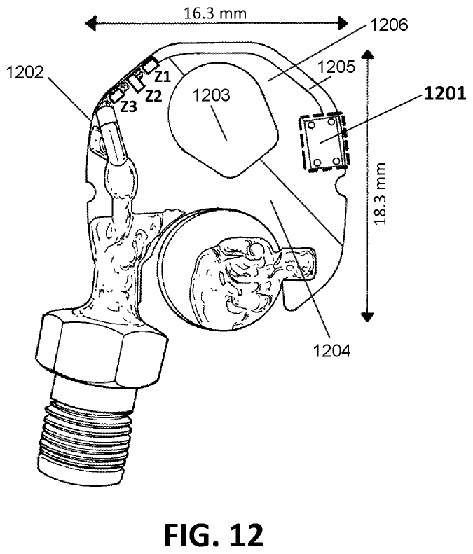

FIG. 12 provides an embodiment of a radiating system related to this disclosure contained in a PCB 1202 that features a polygonal shape, different from a rectangle, and wherein the PCB is perforated 1203. So, the ground plane layer 1204 of this radiating structure features a rare shape. This is another radiating system embodiment comprising an embedded structure that comprises an embedded radiation booster 1201 of dimensions 0.12 mm×0.08 mm, the embedded structure and radiation booster integrated in the PCB of the radiating structure. The radiation booster comprises two conductive surfaces at the top and bottom layers of the PCB, connected by 4 vias near the four corners of the radiation booster. The radiation booster can also be perforated at the center of the top conductive surface, the surface featuring a closed ring shape then. The dimensions of the PCB are 16.3 mm×18.3 mm (horizontal diameter×vertical diameter) as shown in the illustration from FIG. 12, and thickness 0.43 mm. The embedded radiation booster is connected to a matching network (represented by elements Z1, Z2 and Z3 in the illustration) through a conductive strip 1205, no straight in shape but following the PCB shape. The embedded radiation booster and conductive strip have a ground plane clearance 1206.

In this text, the term “includes,” “comprises,” and derivations thereof (such as “including,” “comprising,” etc.) should not be understood in an excluding sense, that is, these terms should not be interpreted as excluding the possibility that what is described and defined may include further elements, steps, etc. On the other hand, the disclosure is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

What is claimed is:

1. A wireless device, including a radiating system comprising:
a radiating structure comprising:
an embedded structure in a dielectric support, the embedded structure comprising:
an antenna element comprising a conductive surface including a conductive layer;
a feeding line;
an electrical connection from a first layer to a second layer of the dielectric support; and
a dielectric material; and
a ground plane layer;
an I/O port; and
a radiofrequency system comprising a matching network or circuit on a pads layout,
wherein the ground plane layer is not in the dielectric support.

2. The wireless device of claim 1, wherein the dielectric support supports the pads layout.

3. The wireless device of claim 1, wherein the pads layout is on the ground plane layer.

4. The wireless device of claim 1, further comprising a second ground plane layer, wherein the dielectric support is on a portion of the second ground plane layer.

5. The wireless device of claim 1, wherein the pads layout is on a portion of the ground plane layer that is not in the dielectric support.

6. The wireless device of claim 1, wherein the antenna element is a radiation booster.

7. The wireless device of claim 6, wherein the radiation booster comprises first and second conductive layers.

8. The wireless device of claim 7, wherein the first and second conductive layers have different shapes.

9. The wireless device of claim 1, wherein the antenna element is an electrically-short antenna.

10. The wireless device of claim 1, wherein the radiating system is configured to make the wireless device operate in a single frequency band.

11. The wireless device of claim 1, wherein the radiating system is configured to make the wireless device operate in first and second frequency regions and/or frequency bands.

12. A wireless device, including a radiating system that comprises:
a radiating structure comprising:
an embedded structure in a dielectric support, the embedded structure comprising:
an antenna element comprising a conductive surface including a conductive layer;
a feeding line;
an electrical connection from a first layer to a second layer of the dielectric support; and
a dielectric material; and
a ground plane layer;
an I/O port; and
a radiofrequency system comprising a matching network or circuit on a pads layout,
wherein the dielectric support is on a portion of the ground plane layer.

13. The wireless device of claim 12, wherein the dielectric support supports the pads layout.

14. The wireless device of claim 13, wherein the pads layout is on the ground plane layer.

15. The wireless device of claim 12, wherein the pads layout is on a portion of the ground plane layer other than the portion of the ground plane layer that the dielectric support is on.

16. The wireless device of claim 12, wherein the antenna element is a radiation booster.

17. The wireless device of claim 16, wherein the radiation booster comprises first and second conductive layers.

18. The wireless device of claim 17, wherein the first and second conductive layers of the radiation booster have different shapes.

19. The wireless device of any one of claims 12, wherein the antenna element is an electrically-short antenna.

20. The wireless device of claim 12, wherein the radiating system is configured to make the wireless device operate in a single frequency band.

21. The wireless device of claim 12, wherein the radiating system is configured to make the wireless device operate in first and second frequency regions and/or frequency bands.

22. A method, comprising:
arranging a radiating structure within a wireless device, the radiating structure comprising: an embedded structure in a dielectric support, and at least one ground plane layer;
arranging at least one I/O port within the wireless device; and
arranging, within the wireless device, a radiofrequency system that comprises a matching network or circuit on a pads layout,
wherein the embedded structure comprises: an antenna element comprising at least one conductive surface comprised in at least one conductive layer, a feeding line, at least one electrical connection from a first layer to a second layer, and a dielectric material, and
wherein the radiating structure is arranged within the wireless device such that at least one layer of the at least one ground plane layer is not in the dielectric support.

23. A method, comprising:
arranging a radiating structure within a wireless device, the radiating structure comprising: an embedded structure in a dielectric support, and a ground plane layer;
arranging at least one I/O port within the wireless device; and
arranging, within the wireless device, a radiofrequency system comprising a matching network or circuit on a pads layout,
wherein the embedded structure comprises: an antenna element comprising a conductive surface including a conductive layer, a feeding line, an electrical connection from a first layer to a second layer of the dielectric support, and a dielectric material, and
wherein the dielectric support is on a portion of the ground plane layer.
